(19) United States
(12) Patent Application Publication
(10) Pub. No.: US 2025/0035801 A1
(43) Pub. Date: Jan. 30, 2025

(54) AUTONOMOUS AERIAL DISTRIBUTED FIBER-OPTIC SENSING DEVICE

(71) Applicant: SAUDI ARABIAN OIL COMPANY, Dhahran (SA)

(72) Inventors: Nour M. Alzamil, Dammam (SA); Ezzedeen Alfataierge, Dhahran (SA)

(73) Assignee: SAUDI ARABIAN OIL COMPANY, Dhahran (SA)

(21) Appl. No.: 18/357,730

(22) Filed: Jul. 24, 2023

(51) Int. Cl. G01V 1/18; G01H 9/00; G01V 1/42; G05D 1/661; G05D 105/80; G05D 109/25; G06Q 10/0631

(52) U.S. Cl. CPC G01V 1/18; G01H 9/004; G05D 1/661; G06Q 10/06311; G01V 1/42; G05D 2105/80; G05D 2109/254

(57) ABSTRACT

A method to perform measurements of a field is disclosed. The method includes disposing a landing dock at a target location in the field, the landing dock being coupled to a fiber optic cable for distributed fiber-optic sensing measurement, directing an unmanned aerial vehicle (UAV) to land on the landing dock, the UAV including an interrogator unit, communicatively coupling, in response to the UAV landing on the landing dock, the interrogator unit and the fiber optic cable, sending, by the interrogator unit, a light pulse to the fiber optic cable, receiving, by the interrogator unit and in response to sending the light pulse, a backscattered light signal from the fiber optic cable, and generating, by the interrogator unit and based on the received backscattered light signal, a measurement of the target location.

### BACKGROUND

Distributed fiber-optic sensing is a measurement technique that uses optical fibers as the sensing element to infer a measurement (e.g., temperature, strain, pressure, etc.). The process of acquiring such measurements requires an interrogation device known as the interrogator. An interrogator is a measurement device that sends a series of laser light pulses into the optical fiber and records the backscattered light signal with respect to time. During the measurement recording, the optical fiber is not active (referred to as a dark fiber in this state) in transmitting any light other than the laser light pulses from the interrogator. The measured backscattered light is analyzed via different methods to extract sensor-type measurements at distributed points along the fiber optic cable. Distributed Acoustic Sensing (DAS) is the technique to acquire acoustic measurements using distributed fiber-optic sensing. Distributed Temperature sensing (DTS) is the technique to acquire temperature measurements using distributed fiber-optic sensing. Distributed fiber-optic sensing may also be used to acquire other types of measurements, such as strain measurements, pressure measurements, acoustic measurements, etc. The methods described are applied in practice through manual operations that are sometimes performed in remote environments. This requires the presence of experience personnel in the field as well as operation vehicles to house the necessary equipment to conduct the measurement acquisition.

### SUMMARY

In general, in one aspect, the invention relates to a method to perform measurements of a field. The method includes disposing a landing dock at a target location in the field, the landing dock being coupled to a fiber optic cable for distributed fiber-optic sensing measurement, directing an unmanned aerial vehicle (UAV) to land on the landing dock, the UAV comprising an interrogator unit, communicatively coupling, in response to the UAV landing on the landing dock, the interrogator unit and the fiber optic cable, sending, by the interrogator unit, a light pulse to the fiber optic cable, receiving, by the interrogator unit and in response to sending the light pulse, a backscattered light signal from the fiber optic cable, and generating, by the interrogator unit and based on the received backscattered light signal, a measurement of the target location.

In general, in one aspect, the invention relates to a well system that includes a wellbore at a target location in a field, a fiber optic cable suspended in the wellbore for distributed fiber-optic sensing measurement, and a landing dock disposed adjacent to a wellhead of the wellbore and coupled to the fiber optic cable, wherein the landing dock is configured for an unmanned aerial vehicle (UAV) to land, the UAV comprising an interrogator unit, wherein the fiber optic cable is configured to communicatively couple, in response to the UAV landing on the landing dock, to the interrogator unit, and receive, from the interrogator unit, a light pulse to generate a backscattered light signal, and wherein the interrogator unit is configured to send the light pulse and receive the backscattered light signal from the fiber optic cable, and generate, based on the received backscattered light signal, a measurement of the target location.

In general, in one aspect, the invention relates to an unmanned aerial vehicle (UAV) that includes a controller configured to direct the UAV to land on a landing dock, wherein the landing dock is disposed adjacent to a wellbore at a target location in a field and coupled to a fiber optic cable suspended in the wellbore for distributed fiber-optic sensing measurement, and an interrogator unit configured to communicatively couple, in response to the UAV landing on the landing dock, to the fiber optic cable, send, in response to communicatively coupling to the fiber optic cable, a light pulse to the fiber optic cable, receive, in response to sending the light pulse, a backscattered light signal from the fiber optic cable, and generate, based on the received backscattered light signal, a measurement of the target location.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIGS. 1A-1C show schematic diagrams in accordance with one or more embodiments.

FIG. 2 shows a method flowchart in accordance with one or more embodiments.

FIGS. 3A-3B show an example in accordance with one or more embodiments.

FIG. 4 shows a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (for example, first, second, third) may be used as an adjective for an element (that is, any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the disclosure include a method and system for performing measurements of a field. For example, the field may be an oil and gas field or any other field equipped with fiber optic cable for data communication. In one or more embodiments of the invention, a landing dock is disposed at a target location in the field and coupled to a fiber optic cable for distributed fiber-optic sensing measurement. An unmanned aerial vehicle (UAV) having an interrogator unit is directed to land on the landing dock. In response to the UAV landing on the landing dock, the interrogator unit and the fiber optic cable are communicatively coupled to each other. For example, a male connector on the UAV may be plugged into a female connector on the landing dock where the connector housing establishes the power connection and the fiber-optic connection. In particular, the power connection supplies power to the instrument and the fiber-optic connection enables optical fiber for interrogation, etc. Accordingly, a light pulse is sent by the interrogator unit to the fiber optic cable and a resulting backscattered light signal is received by the interrogator unit from the fiber optic cable. Based on the received backscattered light signal, a measurement of the target location is generated by the interrogator unit. In one or more embodiments, the measurements are used for Vertical Seismic Profiling (VSP) acquisition and other applications such as precision agriculture, forest fire monitoring, river or other environmental monitoring, surveillance, infrastructure inspections, etc.

In the example of fiber installation in a well, the interrogator unit measures DAS or DTS, which can be part of a VSP survey, or can be a standalone survey to assess the well and measure the well conditions. Additional applications are possible with other installations. For example, a fiber optic cable installed on a pipeline can be equipped a similar landing dock setup to allow measurements using the UAV mounted interrogator unit to assess the pipeline conditions, such as measuring fluid flow, detecting any possible leaks, monitoring security of the pipeline, etc. Further additional applications may include fiber optical cables deployed for telephone, internet, cross-continent communication, security applications, earthquake monitoring, geolocation monitoring, etc. that can be interrogated using a laser of the interrogator unit.

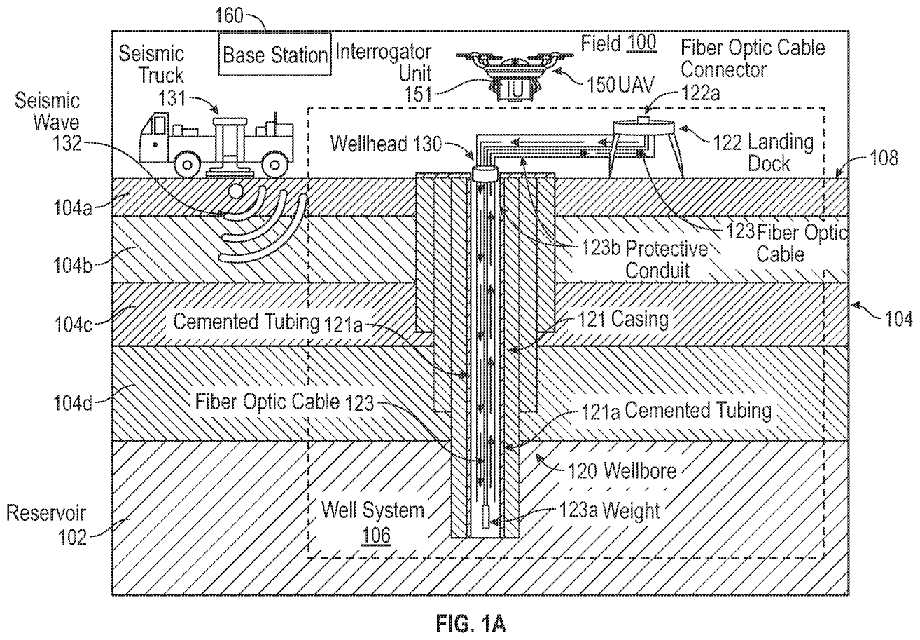

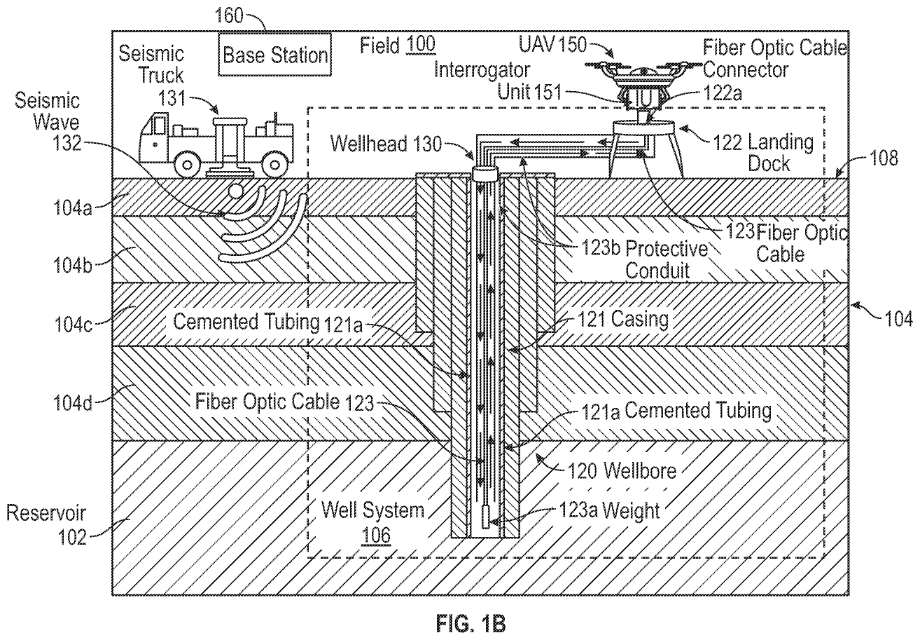

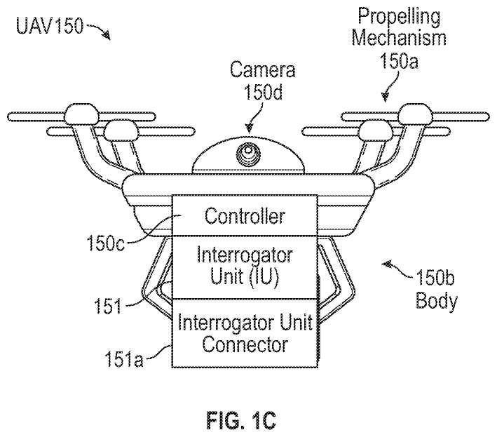

FIGS. 1A-1C show schematic diagrams in accordance with one or more embodiments. In one or more embodiments, one or more of the modules and/or elements shown in FIGS. 1A-1C may be omitted, repeated, combined and/or substituted. Accordingly, embodiments disclosed herein should not be considered limited to the specific arrangements of modules and/or elements shown in FIGS. 1A-1C.

More specifically, FIG. 1A illustrates a well environment in a field (100) that includes a hydrocarbon reservoir (“reservoir”) (102) located in a subsurface hydrocarbon-bearing formation (“formation”) (104) and a well system (106). The well system (106) is among multiple (e.g., hundreds, thousands, etc.) well systems located throughout a field, which is a large geographical area (e.g., hundreds, thousands, hundreds of thousands square miles) where the reservoir (102) is located. The hydrocarbon-bearing formation (104) may include a porous or fractured rock formation that resides underground, beneath the Earth's surface (“surface”) (108). The surface (108) may be over land or under water, such as an ocean floor. In the case of the well system (106) being a hydrocarbon well, the reservoir (102) may include a portion of the hydrocarbon-bearing formation (104). The hydrocarbon-bearing formation (104) and the reservoir (102) may include different layers (104a, 104b, 104c, 104d) of rock (referred to as formation layers) having varying characteristics, such as varying degrees of permeability, porosity, capillary pressure, and resistivity. In the case of the well system (106) being operated as a production well, the well system (106) may facilitate the extraction of hydrocarbons (or “production”) from the reservoir (102). In other cases, the well system (106) may correspond to an exploratory well, an injection well, a well being drilled, an abandoned well, etc.

In some embodiments, the well system (106) includes a wellbore (120) and a landing dock (122). Various operations may be performed for the well system (106), such as well production operations, well completion operations, well maintenance operations, and reservoir monitoring, assessment and development operations.

In some embodiments, a casing (121) is installed in the wellbore (120). For example, the wellbore (120) may have a cased portion and an uncased (or “open-hole”) portion. The cased portion may include a portion of the wellbore having the casing (121) and a cemented tubing (121a). The uncased portion may include a portion of the wellbore not having casing disposed therein. In some embodiments, the casing (121) includes an annular casing that lines the wall of the wellbore (120) to form the cemented tubing (121a) as a central passage for the transport of tools and substances through the wellbore (120). For example, the central passage may provide a conduit for lowering logging tools into the wellbore (120), a conduit for the flow of production (121) (e.g., oil and gas) from the reservoir (102) to the surface (108), or a conduit for the flow of injection substances (e.g., water) from the surface (108) into the hydrocarbon-bearing formation (104). In some embodiments, a fiber optic cable (123) is disposed inside cemented tubing (121a) and protected by a protective conduit (123b) to perform distributed fiber-optic sensing measurements. The fiber optic cable (123) may be suspended by a weight (123a). For example, the distributed fiber-optic sensing measurements may correspond to characteristics of substances, e.g., hydrocarbon production, injection fluids, drilling fluids, etc. passing through or otherwise located in the wellbore (120). The characteristics may include, for example, pressure, temperature, vibration, strain, flow rate, etc. as a function of depth within the wellbore (120). In another example, the distributed fiber-optic sensing measurements may correspond to acoustic measurements of the seismic wave (132) originated from a seismic source, such as a seismic truck (131) at the surface (108). The acoustic measurements represent characteristics of formation layers (104a, 104b, 104c, 104d) penetrated by the wellbore (120) in the formation (104).

In some embodiments, the well system (106) includes a wellhead (130). The wellhead (130) may include a rigid structure installed at the “up-hole” end of the wellbore (120), at or near where the wellbore (120) terminates at the surface (108). The wellhead (130) may include structures for supporting (or “hanging”) casing and production tubing extending into the wellbore (120). As shown in FIG. 1A, the protective conduit (123b) and the fiber optic cable (123) exit the wellbore (120) through the wellhead (130) to terminate at a fiber optic cable connector (122a) on the landing dock (122). The landing dock (122) is a mechanical structure, such as a raised platform where an unmanned aerial vehicle (UAV) (150) may land. In some embodiments, the landing dock (122) includes alignment marks, such as a pattern or structure on the surface or embedded within a material of the landing dock (122), or otherwise associated with the fiber optic cable connector (122a). The alignment marks facilitate aligning the fiber optic cable connector (122a) and an interrogator unit connector (151a) during the landing of the UAV (150) onto the landing dock (122).

In some embodiments, the UAV (150) is an unmanned aerial vehicle (UAV) also known as a drone, which is an aircraft without any human pilot, crew, or passengers on board. The UAV (150) is equipped with a distributed fiber-optic sensing interrogator unit (IU) (151) to perform autonomous acquisition of distributed fiber-optics sensing measurements at multiple target locations in the field. In some embodiments, the UAV (150) is directed by a flight control center to fly from a base station (160) to land on the landing dock (122). In this context, the location of the wellbore (120) and landing dock (122) is referred to as a target location among many other target locations in the field. A human operator or an automated controller in the flight control center navigates the UAV (150) by sending commands to and receiving images or other information from the UAV (150) via wireless communication. The flight control center may be located at the base station (160) or away from the base station (160). In some embodiments, the UAV (150) may be directed to fly to different target locations for landing on respective landing docks according to a pre-defined schedule along a monitoring data collection route, in response to an alert from the well system at a particular target location, or intermittently as dispatched by an operator in the base station (160).

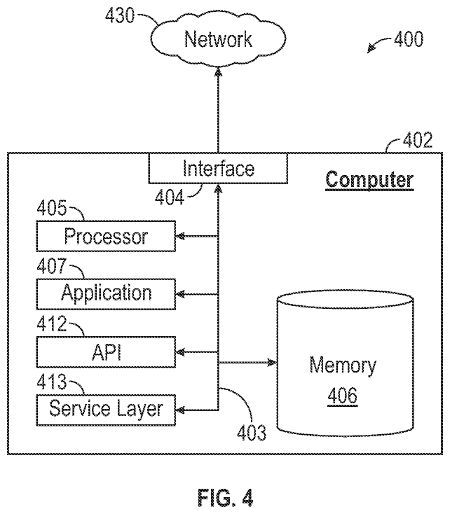

In some embodiments, the base station (160) is a facility where the UAV (150) is parked when not in service or during maintenance. The base station (160) is provided with computer systems, similar to the computer system (400) described in reference to FIG. 4 below, for performing functionalities of the base station (160). For example, the computer systems may include a reservoir simulator, a field management analyzer, or other analysis software that analyzes measurements obtained from multiple target locations in the field to generate analysis results. The analysis results may relate to hydrocarbon production, wellbore maintenance alerts, or other operations across the field. In addition, different types of fiber-optic installation can be done at different levels, such as behind the casing, on the tubing, or placed inside the wellbore. Accordingly, different information may be inferred from the measured DAS/DTS data to include in the analysis results for each installation type. For example, optical fiber installed on/behind casing would help assess the casing condition and the cement in place in the analysis results, while optical fiber installed in the wellbore or on the tubing would not be able to make such assessment in the analysis results.

In some embodiments, an operation crew may be dispatched by the base station (160) to the target location to perform a field operation based on the analysis results. For example, the field operation may include adjusting a wellbore production operation, performing a wellbore maintenance operation, or other types of field operation.

Turning to FIG. 1B, FIG. 1B illustrates the landing configuration of the well environment depicted in FIG. 1A above. As shown in FIG. 1B, the UAV (150) is disposed (landed) on the landing dock (122) with the IU (151) connected to the fiber optic cable (123) via the fiber optic cable connector (122a) on the landing dock. In some embodiments, the IU (151) connects to the fiber optic cable (123) for acquiring seismic data of the Vertical Seismic Profiling (VSP) acquisition method. In particular, the IU (151) emits laser pulses into the fiber optic cable (123) and records the backscattered energy response due to fiber vibration. The fiber is vibrated in response to the seismic wave (132) originated from a source (e.g., vibroseis) on the seismic truck (131). The IU (151) can record different measurements simultaneously such as pressure, strain, and temperature using multimode optic fiber.

While the fiber optic cable installations are depicted in FIGS. 1A-1B as part of a well completion for oil and gas operations, alternative fiber optic cable installations are also possible as part of a monitoring well setup or other surface setup without any borehole, such as for precision agriculture, forest fire monitoring, river or other environmental monitoring, surveillance, infrastructure inspections, etc. All of these surface setups include a specialized landing dock to host the UAV and allow for connection to the pre-installed fiber optic cable. Accordingly, the UAV allows for efficient delivery and connection of an IU to the pre-installed fiber optic setup to extract measurements of interest, e.g., temperature, pressure, seismic, etc.

Although the field (100) depicted in FIGS. 1A-1B above includes a well environment in an oil and gas field, additional applications of the fiber optic interrogator using a laser are possible with other installations that are not related to any well environment. For example, a fiber optic cable installed on a pipeline may be equipped with a similar landing dock setup to allow measurements using the UAV mounted interrogator unit to assess the pipeline conditions, such as measuring fluid flow, detecting any possible leaks, monitoring security of the pipeline, etc. Further additional applications may include interrogation of fiber optical cables deployed over land or the ocean floor for telephone and internet communication. In one or more embodiments, the fiber optic interrogator may be used in security applications, earthquake monitoring, geolocation monitoring, or any other suitable environment in which fiber optic cables are employed and may need to be interrogated for integrity or various other reasons.

Turning to FIG. 1C, FIG. 1C illustrates further details of the UAV (150). As shown in FIG. 1C, the UAV (150) includes a propelling mechanism (150a) and a camera (150d) that are mounted on a body (150b). The propelling mechanism (150a) is a mechanism (e.g., propellers) for providing lift and drive to fly the UAV (150) in the air. The body (150b) is a mechanical housing that encloses a controller (150c) and the IU (151). The controller (150c) is a module that includes hardware, software, or a combination of hardware and software to perform functionalities of navigating the UAV (150) and controlling the IU (151). For example, the controller (150c) may include wireless communication circuit and software to receive navigation commends from and send camera images or other information to the aforementioned flight control center. In some embodiments, the distributed fiber optic sensing measurements are wirelessly transmitted by the controller (150c) to the base station (160). The camera images are captured using the camera (150d) and may include in-flight terrestrial images for navigation, landing dock images for alignment, or other relevant images. The IU (151) includes optical circuits and software to perform distributed fiber-optic sensing. For example, the IU (151) may include a laser light source, a backscattered light signal receiver, a data storage, a wireless communication interface, and an interface to the controller (150c). In some embodiments, the distributed fiber optic sensing measurements are wirelessly transmitted by the IU (151) to the base station (160). In some embodiments, the distributed fiber optic sensing measurements are stored in the data storage of the IU (151) and retrieved when the UAV (150) returns to the base station (160). In addition, the IU (151) includes an IU connector (151a). In particular, the IU connector (151a) and the fiber optic cable connector (122a) are optical fiber connectors that mechanically couple and align the cores of fiber optic cables so light can pass.

In some embodiments, the distributed fiber optic sensing measurements are recorded and transmitted to the base station in real-time, and are available for review, analysis or other use within seconds, minutes or hours of the condition being sensed (e.g., the measurements are available within 1 hour of the condition being sensed). In such embodiments, the distributed fiber optic sensing measurements may be referred to as “real-time” measurements of the target location. While the UAV (150) is docked on the landing dock (122), real-time measurements of the target location may enable an operator of the base station (160) to assess a relatively current state of the well system (106), and make real-time decisions regarding the well system (106) and the reservoir (102), such as on-demand adjustments in regulation of production flow from the well.

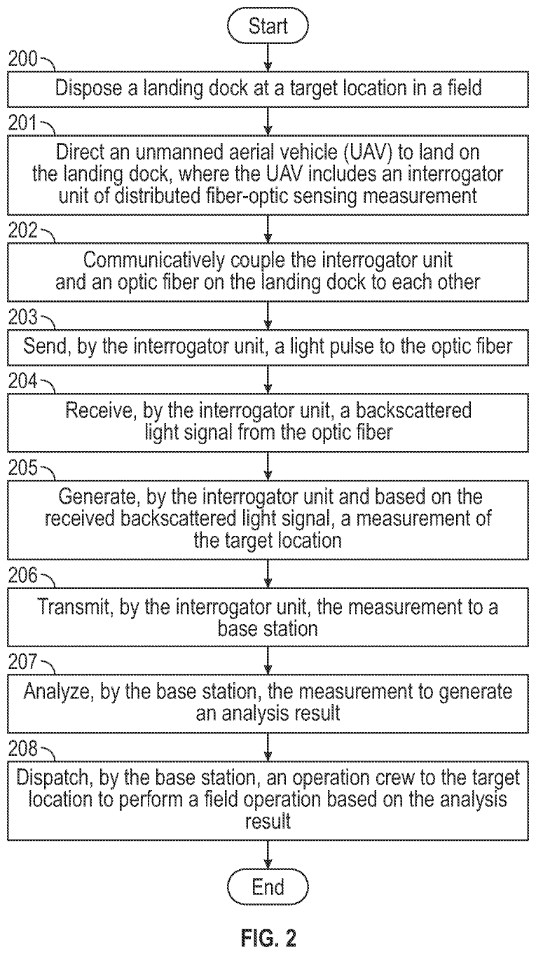

FIG. 2 shows a flowchart in accordance with one or more embodiments disclosed herein. One or more of the steps in FIG. 2 may be performed by the components of the well system (106) discussed above in reference to FIGS. 1A-1C. In one or more embodiments, one or more of the steps shown in FIG. 2 may be omitted, repeated, and/or performed in a different order than the order shown in FIG. 2. Accordingly, the scope of the disclosure should not be considered limited to the specific arrangement of steps shown in FIG. 2.

As shown in FIG. 2, the flowchart illustrates a method to perform measurements of a field. Initially in Step 200, a landing dock is disposed at a target location in the field where the landing dock is coupled to a fiber optic cable for distributed fiber-optic sensing measurement at the target location. In one or more embodiments of the invention, the fiber optic cable is suspended in a wellbore at the target location for measuring downhole parameters, such as seismic measurement, temperature measurement, pressure measurement, strain measurement, etc. For example, the fiber optic cable may be cemented behind the casing of the wellbore. In such embodiments, the field may be an oil or gas field for producing hydrocarbons where the landing dock is disposed nearby a wellhead of the wellbore.

In Step 201, an unmanned aerial vehicle (UAV) is directed to land on the landing dock where the UAV includes an interrogator unit of the distributed fiber-optic sensing measurement. For example, the UAV may be directed by a landing command, among other navigation commands, received from a flight control center via wireless communication. The flight control center may be a part of a base station of the field or separate from the base station. In particular, the UAV is directed to land on the landing dock while aligning an interrogator unit connector on the UAV to a fiber optic cable connector on the landing dock. In one or more embodiments, the alignment is performed by a user in the flight control center remotely viewing alignment marks on the landing dock and manually maneuvering the UAV to a pre-defined position above the landing dock for aligning the interrogator unit connector and the fiber optic cable connector before landing. For example, the user may remotely view the alignment marks on the landing dock through a camera of the UAV transmitting real-time images of the landing dock to the flight control center.

In Step 202, in response to the UAV landing on the landing dock, the interrogator unit and the fiber optic cable are communicatively coupled to each other. Specifically, the interrogator unit and the fiber optic cable are communicatively coupled by connecting the interrogator unit connector and the fiber optic cable connector for sending light pulses and receiving backscattered light signals. As noted above, the interrogator unit connector and the fiber optic cable connector are optical fiber connectors that mechanically couple and align the cores of fiber optic cables so light can pass.

In Step 203, a light pulse is sent by the interrogator unit to the fiber optic cable. In one or more embodiments, the light pulse is a laser light pulse sent from a laser light source of the interrogator unit.

In Step 204, in response to sending the light pulse, a backscattered light signal is received by the interrogator unit from the fiber optic cable. In one or more embodiments, the backscattered light signal is received by a laser light sensor of the interrogator unit. In other words, the laser light sensor acts as a backscattered light signal receiver.

In Step 205, a measurement of the target location is generated by the interrogator unit based on the received backscattered light signal. In one or more embodiments, the fiber optic cable is a single mode fiber optic cable for single mode transmission and the received backscattered light signal is converted to a digital value representing one of a seismic measurement, temperature measurement, pressure measurement, strain measurement, etc. In one or more embodiments, the fiber optic cable is a multimode fiber optic cable for multimode transmission and the received backscattered light signal is converted to digital values representing two or more of a seismic measurement, temperature measurement, pressure measurement, strain measurement, etc.

In Step 206, the measurement is transmitted by the interrogator unit to a base station. In one or more embodiments, the measurement is transmitted to the base station via wireless communication. In one or more embodiments, the measurement is stored in a data storage of the interrogator unit. Subsequently, the UAV is directed to disengage from the landing dock and return to the base station. As noted above, the UAV may be directed by a disengaging and returning command from the flight control center. Upon the UAV returning to the base station, the measurement is retrieved from the data storage of the interrogator unit.

In Step 207, the measurement is analyzed by the base station to generate an analysis result. In one or more embodiments, the measurement is analyzed using a computer system of the base station. For example, the computer system may include a reservoir simulator, a field management analyzer, or other analysis software that analyzes measurements obtained from multiple target locations in the field to generate the analysis results. Accordingly, the analysis results may relate to the hydrocarbon production, wellbore maintenance alerts, or other operations across the field.

In Step 208, an operation crew is dispatched by the base station to the target location to perform a field operation based on the analysis result. For example, performing the field operation may relate to adjusting a wellbore production operation, performing a wellbore maintenance operation, or other types of field operation.

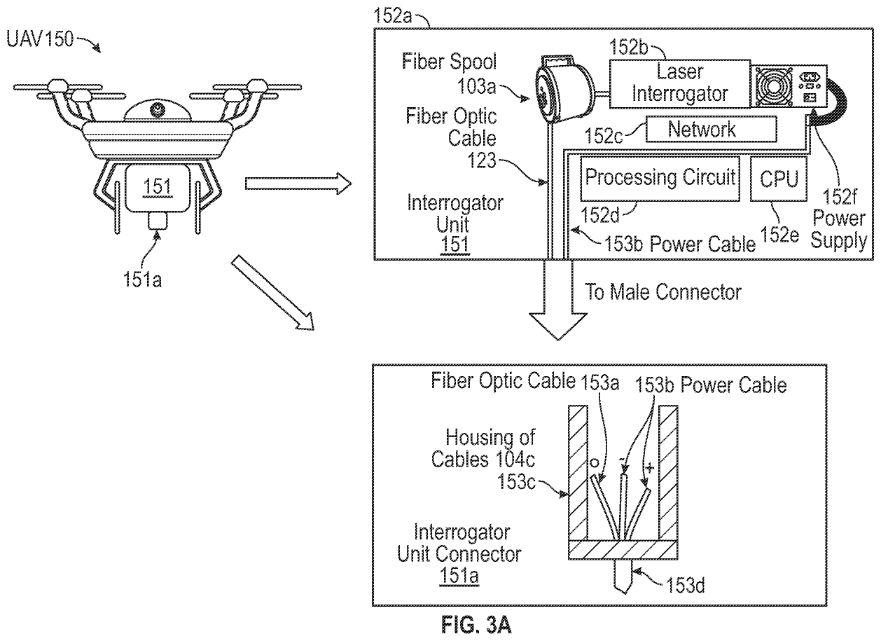

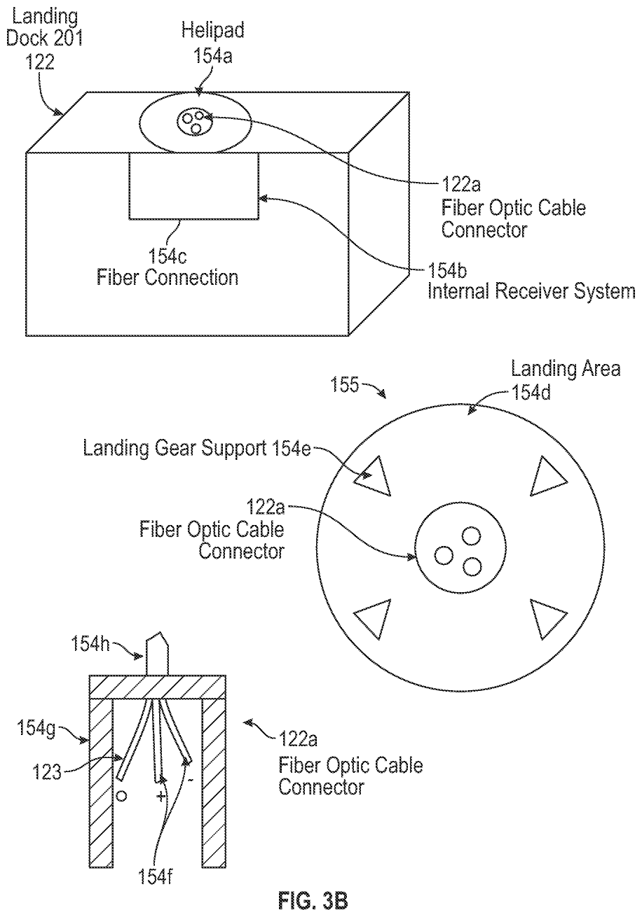

FIGS. 3A-3B show an example in accordance with one or more embodiments. In one or more embodiments, one or more of the modules and/or elements shown in FIGS. 3A-3B may be omitted, repeated, combined and/or substituted. Accordingly, embodiments disclosed herein should not be considered limited to the specific arrangements of modules and/or elements shown in FIGS. 3A-3B.

More specifically, FIG. 3A illustrates example details of the interrogator unit (151) and the interrogator unit connector (151a) of the UAV (150) depicted in FIGS. 1A-1C above. In this example, the interrogator unit connector (151a) is a male connector. As shown in FIG. 3A, the interrogator unit (151) includes a fiber spool (152a) for spooling the fiber optic cable (153a), a laser interrogator (152b) for generating the laser beam passing through the fiber optic cable, and a power supply (152f) for supplying electrical power to the laser interrogator (152b) and other electronic components such as a network (152c), processing circuit (152d), and a central processing unit (CPU) (152e) that collectively perform signal and data processing tasks of the interrogator unit (151). A power cable (153b) connects the power supply (152f) and the interrogator unit connector (151a) for supplying electrical power to the landing dock (122) upon landing of the UAV (150). The power cable (153b) and the fiber optic cable (153a) are protected by a housing of cables (153c) from which a male connector shroud (153d) protrudes downward.

FIG. 3B illustrates example details of the landing dock (122) and the fiber optic cable connector (122a) depicted in FIGS. 1A-1B above. In this example, the fiber optic cable connector (122a) is a female connector. As shown in FIG. 3B, the landing dock (122) includes a helipad (154a), the fiber optic cable connector (122a), an internal receiver system (154b), and a fiber connection (154c). The internal receiver system (154b) includes a power source that supplies electrical power to the UAV (150) besides the interrogator unit (151). Further, the internal receiver system (154b) includes fiber connection to pre-installed network of fiber optic cable (123). A top view (155) of the helipad (154a) shows a landing area (154d) where the UAV (150) will land and be secured by a landing gear support (154e) for stability. Upon landing, the interrogator unit connector (151a) (a male connector) of the UAV (150) is connected to the fiber optic cable connector (122a) (a female connector). The power cables in the male connector has an opposite order from the female connector. A power cable (154f) connects the power source in the internal receiver system (154b) and the fiber optic cable connector (122a). The power cable (154f) and the fiber optic cable (123) are protected by a housing of cables (154g) from which a female connector shroud (154h) protrudes upward.

Embodiments may be implemented on a computer system. FIG. 4 is a block diagram of a computer system (402) used to provide computational functionalities associated with described algorithms, methods, functions, processes, flows, and procedures as described in the instant disclosure, according to an implementation. The illustrated computer (402) is intended to encompass any computing device such as a high performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (402) may include a computer that includes an input device, such as a keypad, keyboard, touch screen, or other device that can accept user information, and an output device that conveys information associated with the operation of the computer (402), including digital data, visual, or audio information (or a combination of information), or a GUI.

The computer (402) can serve in a role as a client, network component, a server, a database or other persistency, or any other component (or a combination of roles) of a computer system for performing the subject matter described in the instant disclosure. The illustrated computer (402) is communicably coupled with a network (430). In some implementations, one or more components of the computer (402) may be configured to operate within environments, including cloud-computing-based, local, global, or other environment (or a combination of environments).

At a high level, the computer (402) is an electronic computing device operable to receive, transmit, process, store, or manage data and information associated with the described subject matter. According to some implementations, the computer (402) may also include or be communicably coupled with an application server, e-mail server, web server, caching server, streaming data server, business intelligence (BI) server, or other server (or a combination of servers).

The computer (402) can receive requests over network (430) from a client application (for example, executing on another computer (402)) and responding to the received requests by processing the said requests in an appropriate software application. In addition, requests may also be sent to the computer (402) from internal users (for example, from a command console or by other appropriate access method), external or third-parties, other automated applications, as well as any other appropriate entities, individuals, systems, or computers.

Each of the components of the computer (402) can communicate using a system bus (403). In some implementations, any or all of the components of the computer (402), both hardware or software (or a combination of hardware and software), may interface with each other or the interface (404) (or a combination of both) over the system bus (403) using an application programming interface (API) (412) or a service layer (413) (or a combination of the API (412) and service layer (413). The API (412) may include specifications for routines, data structures, and object classes. The API (412) may be either computer-language independent or dependent and refer to a complete interface, a single function, or even a set of APIs. The service layer (413) provides software services to the computer (402) or other components (whether or not illustrated) that are communicably coupled to the computer (402). The functionality of the computer (402) may be accessible for all service consumers using this service layer. Software services, such as those provided by the service layer (413), provide reusable, defined business functionalities through a defined interface. For example, the interface may be software written in JAVA, C++, or other suitable language providing data in extensible markup language (XML) format or another suitable format. While illustrated as an integrated component of the computer (402), alternative implementations may illustrate the API (412) or the service layer (413) as stand-alone components in relation to other components of the computer (402) or other components (whether or not illustrated) that are communicably coupled to the computer (402). Moreover, any or all parts of the API (412) or the service layer (413) may be implemented as child or sub-modules of another software module, enterprise application, or hardware module without departing from the scope of this disclosure.

The computer (402) includes an interface (404). Although illustrated as a single interface (404) in FIG. 4, two or more interfaces (404) may be used according to particular needs, desires, or particular implementations of the computer (402). The interface (404) is used by the computer (402) for communicating with other systems in a distributed environment that are connected to the network (430). Generally, the interface (404) includes logic encoded in software or hardware (or a combination of software and hardware) and operable to communicate with the network (430). More specifically, the interface (404) may include software supporting one or more communication protocols associated with communications such that the network (430) or interface's hardware is operable to communicate physical signals within and outside of the illustrated computer (402).

The computer (402) includes at least one computer processor (405). Although illustrated as a single computer processor (405) in FIG. 4, two or more processors may be used according to particular needs, desires, or particular implementations of the computer (402). Generally, the computer processor (405) executes instructions and manipulates data to perform the operations of the computer (402) and any algorithms, methods, functions, processes, flows, and procedures as described in the instant disclosure.

The computer (402) also includes a memory (406) that holds data for the computer (402) or other components (or a combination of both) that can be connected to the network (430). For example, memory (406) can be a database storing data consistent with this disclosure. Although illustrated as a single memory (406) in FIG. 4, two or more memories may be used according to particular needs, desires, or particular implementations of the computer (402) and the described functionality. While memory (406) is illustrated as an integral component of the computer (402), in alternative implementations, memory (406) can be external to the computer (402).

The application (407) is an algorithmic software engine providing functionality according to particular needs, desires, or particular implementations of the computer (402), particularly with respect to functionality described in this disclosure. For example, application (407) can serve as one or more components, modules, applications, etc. Further, although illustrated as a single application (407), the application (407) may be implemented as multiple applications (407) on the computer (402). In addition, although illustrated as integral to the computer (402), in alternative implementations, the application (407) can be external to the computer (402).

There may be any number of computers (402) associated with, or external to, a computer system containing computer (402), each computer (402) communicating over network (430). Further, the term “client,” “user,” and other appropriate terminology may be used interchangeably as appropriate without departing from the scope of this disclosure. Moreover, this disclosure contemplates that many users may use one computer (402), or that one user may use multiple computers (402).

In some embodiments, the computer (402) is implemented as part of a cloud computer system. For example, a cloud computer system may include one or more remote servers along with various other cloud components, such as cloud storage units and edge servers. In particular, a cloud computer system may perform one or more computing operations without direct active management by a user device or local computer system. As such, a cloud computer system may have different functions distributed over multiple locations from a central server, which may be performed using one or more Internet connections. More specifically, cloud computer system may operate according to one or more service models, such as infrastructure as a service (IaaS), platform as a service (PaaS), software as a service (SaaS), mobile “backend” as a service (MBaaS), serverless computing, artificial intelligence (AI) as a service (AIaaS), and/or function as a service (FaaS).

Embodiments have the following advantages for performing distributed fiber optic sensing measurements, namely (i) automated delivery of the interrogator unit and retrieval for maintenance for a large number of different wells in remote locations throughout a field and (ii) overcoming limitations of a regular interrogator unit by linking UAV's advantages such as flying over to far remote areas in a very short time with eliminating the need of manpower to be physically present in the field.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method to perform measurements of a field, comprising:
disposing a landing dock at a target location in the field, the landing dock being coupled to a fiber optic cable for distributed fiber-optic sensing measurement;
directing an unmanned aerial vehicle (UAV) to land on the landing dock, the UAV comprising an interrogator unit;
communicatively coupling, in response to the UAV landing on the landing dock, the interrogator unit and the fiber optic cable;
sending, by the interrogator unit, a light pulse to the fiber optic cable;
receiving, by the interrogator unit and in response to sending the light pulse, a backscattered light signal from the fiber optic cable; and
generating, by the interrogator unit and based on the received backscattered light signal, a measurement of the target location.

2. The method of claim 1,
wherein said directing comprises aligning an interrogator unit connector on the UAV to a fiber optic cable connector on the landing dock, and
wherein said communicatively coupling comprises connecting the interrogator unit connector and the fiber optic cable connector for sending the light pulse and receiving the backscattered light signal.

3. The method of claim 1, further comprising:
suspending the fiber optic cable in a wellbore at the target location,
wherein the measurement comprises a seismic measurement in the wellbore.

4. The method of claim 1, further comprising:
suspending the fiber optic cable in a wellbore at the target location,
wherein the measurement comprises a temperature measurement in the wellbore.

5. The method of claim 1, further comprising:
suspending the fiber optic cable in a wellbore at the target location,
wherein the measurement comprises a pressure measurement in the wellbore.

6. The method of claim 1, further comprising:
transmitting, by the interrogator unit, the measurement to a base station;
analyzing, by the base station, the measurement to generate an analysis result; and
dispatching, by the base station, an operation crew to the target location to perform a field operation based on the analysis result.

7. The method of claim 1, further comprising:
storing the measurement in a data storage of the interrogator unit;
directing the UAV to disengage from the landing dock and return to a base station of the field;
retrieving, in response to the UAV returning to the base station, the measurement from the data storage of the interrogator unit;
analyzing, in response to said retrieving, the measurement to generate an analysis result; and
dispatching an operation crew to the target location to perform a field operation based on the analysis result.

8. A well system, comprising:
a wellbore at a target location in a field;
a fiber optic cable suspended in the wellbore for distributed fiber-optic sensing measurement; and
a landing dock disposed adjacent to a wellhead of the wellbore and coupled to the fiber optic cable,
wherein the landing dock is configured for an unmanned aerial vehicle (UAV) to land, the UAV comprising an interrogator unit,
wherein the fiber optic cable is configured to:
communicatively couple, in response to the UAV landing on the landing dock, to the interrogator unit; and
receive, from the interrogator unit, a light pulse to generate a backscattered light signal, and
wherein the interrogator unit is configured to:
send the light pulse and receive the backscattered light signal from the fiber optic cable; and
generate, based on the received backscattered light signal, a measurement of the target location.

9. The well system of claim 8,
wherein said directing comprises aligning an interrogator unit connector on the UAV to a fiber optic cable connector on the landing dock, and
wherein said communicatively coupling comprises connecting the interrogator unit connector and the fiber optic cable connector for sending the light pulse and receiving the backscattered light signal.

10. The well system of claim 8,
wherein the measurement comprises a seismic measurement in the wellbore.

11. The well system of claim 8,
wherein the measurement comprises a temperature measurement in the wellbore.

12. The well system of claim 8,
wherein the measurement comprises a pressure measurement in the wellbore.

13. The well system of claim 8,
wherein the interrogator unit transmits the measurement to a base station,
wherein the base station analyzes the measurement to generate an analysis result, and
wherein an operation crew is dispatched to the target location to perform a wellbore operation based on the analysis result.

14. The well system of claim 8,
wherein the measurement is stored in a data storage of the interrogator unit,
wherein the measurement is retrieved from the data storage of the interrogator unit subsequent to the UAV disengaging from the landing dock and returning to a base station of the field, and
wherein an operation crew is dispatched to the target location to perform a wellbore operation based on the measurement.

15. An unmanned aerial vehicle (UAV), comprising:
a controller configured to direct the UAV to land on a landing dock, wherein the landing dock is disposed adjacent to a wellbore at a target location in a field and coupled to a fiber optic cable suspended in the wellbore for distributed fiber-optic sensing measurement; and
an interrogator unit configured to:
communicatively couple, in response to the UAV landing on the landing dock, to the fiber optic cable,
send, in response to communicatively coupling to the fiber optic cable, a light pulse to the fiber optic cable,
receive, in response to sending the light pulse, a backscattered light signal from the fiber optic cable, and
generate, based on the received backscattered light signal, a measurement of the target location.

16. The UAV of claim 15,
wherein said directing comprises aligning an interrogator unit connector on the UAV to a fiber optic cable connector on the landing dock, and
wherein said communicatively coupling comprises connecting the interrogator unit connector and the fiber optic cable connector for sending the light pulse and receiving the backscattered light signal.

17. The UAV of claim 15,
wherein fiber optic cable is configured for single mode transmission, and
wherein the measurement comprises one of a seismic measurement, a temperature measurement, a pressure measurement, and a strain measurement in the wellbore.

18. The UAV of claim 15,
wherein the fiber optic cable is configured for multimode transmission, and
wherein the measurement comprises at least two of a seismic measurement, a temperature measurement, a pressure measurement, and a strain measurement in the wellbore.

19. The UAV of claim 15, the interrogator unit further configured to:
transmit the measurement to a base station,
wherein the base station is configured to:
receive the measurement from the interrogator unit,
analyze the measurement to generate an analysis result, and
dispatch an operation crew to the target location to perform a wellbore operation based on the analysis result.

20. The UAV of claim 15, the interrogator unit further configured to:
store the measurement in a data storage of the interrogator unit for retrieval by a base station,
wherein the base station is configured to:
retrieve the measurement from the data storage of the interrogator unit subsequent to the UAV disengaging from the landing dock and returning to the base station,
analyze, in response to said retrieving, the measurement to generate an analysis result, and
dispatch an operation crew to the target location to perform a wellbore operation based on the analysis result.
